(19) United States
(12) Patent Application Publication
(10) Pub. No.: US 2024/0404046 A1
(43) Pub. Date: Dec. 5, 2024

(54) SUPER-RESOLUTION RECONSTRUCTION DEVICE FOR MICRO-CT IMAGES OF RAT ANKLE

(71) Applicant: Tianjin Baiwangda Technology Co., Ltd., Tianjin City (CN)

(72) Inventors: Hui Yu, Tianjin City (CN); Jinglai Sun, Tianjin City (CN); Liyuan Zhang, Tianjin City (CN); Jing Zhao, Heze City (CN); Chong Liu, Tianjin City (CN)

(21) Appl. No.: 18/327,171

(22) Filed: Jun. 1, 2023

(51) Int. Cl. G06T 7/00; G06T 3/40; G06V 10/24; G06V 10/44; G06V 10/771

(52) U.S. Cl. CPC G06T 7/0012; G06T 3/40; G06V 10/242; G06V 10/44; G06V 10/771; G06T 2207/10081; G06T 2207/20132

(57) ABSTRACT

The present invention proposed a super-resolution reconstruction device for Micro CT images of rat ankle fractures, comprising a rat ankle image preprocessing module, an HR LR image pair configuration module, a deep model module, and an image super-resolution reconstruction module. The aforementioned four modules were sequentially connected; the present invention also proposed an improved R2 RCAN model based on RCAN, which was a super-resolution reconstruction model grounded on self-attention mechanisms that enhanced the model's ability to extract features in multiple scales by incorporating Res2Net. Compared with other classic super-resolution models, the proposed R2 RCAN model achieved the best results.

### FIELD OF THE INVENTION

The present invention pertains to the field of image analysis, specifically focusing on a super-resolution reconstruction device for Micro-CT images of rat ankle.

### BACKGROUND OF THE INVENTION

Fractures are prevalent diseases in contemporary society, and the study of various fracture treatment plans or drug-dependent research relies on animal experiments. Due to the smaller size of animals used in experiments (such as rats), high spatial resolution Micro CT is essential equipment for bone research in animal experiments. Research has shown that high doses of X-rays hinder fracture healing, while low doses of X-rays accelerate cartilage and intramembranous ossification recovery. Considering treatment effectiveness and ethical concerns, adjusting the Micro CT protocol is necessary to safeguard small animals. Therefore, achieving sufficiently clear and high-resolution CT images while minimizing scan time and ionizing radiation is of utmost importance. This enhancement not only boosts the efficiency of animal experimental research and clinical applications but also enhances the safety of animal experiments and future clinical treatments. Super-resolution technology has the potential to convert low-resolution images into high-resolution ones.

### REFERENCES

[1] P. Alcantarilla, J. Nuevo, and A. Bartoli, “Fast Explicit Diffusion for Accelerated Features in Nonlinear Scale Spaces,” in Proceedings of the British Machine Vision Conference 2013, Bristol, 2013, p. 13.1 13.11.
[2] R. Laganiere, OpenCV 2 Computer Vision Application Programming Cookbook.OpenCV 2 computer vision application programming cookbook:, 2011.
[3] Y. Zhang, K. Li, K. Li, L. Wang, B. Zhong, and Y. Fu, “Image Super Resolution Using Very Deep Residual Channel Attention Networks,” in Computer Vision-ECCV 2018, vol. 11211, V. Ferrari, M. Hebert, C. Sminchisescu, and Y. Weiss, Eds. Cham: Springer International Publishing, 2018, pp. 294-310.
[4] S. H. Gao, M. M. Cheng, K. Zhao, X. Y. Zhang, M. H. Yang, and P. Torr, “Res2Net: A New Multi scale Backbone Architecture,” IEEE Trans. Pattern Anal. Mach. Intell., vol. 43, no. 2, pp. 652-662, February 2021.
[5] H. Jie, S. Li, S. Gang, and S. Albanie, “Squeeze and Excitation Networks,” IEEE Transactions on Pattern Analysis and Machine Intelligence, vol. PP, no. 99, 2017.
[6] R. Keys, “Cubic convolution interpolation for digital image processing,” IEEE Trans. Acoust., Speech, Signal Process., vol. 29, no. 6, pp. 1153-1160, December 1981.
[7] C. Dong, C. C. Loy, K. He, and X. Tang, “Learning a Deep Convolutional Network for Image Super Resolution,” in Computer Vision-ECCV 2014, vol. 8692,
D. Fleet, T. Pajdla, B. Schiele, and T. Tuytelaars, Eds. Cham: Springer International 4Publishing, 2014, pp. 184-199
[8] B. Lim, S. Son, H. Kim, S. Nah, and K. M. Lee, “Enhanced Deep Residual Networks for Single Image Super Resolution,” arXiv: 1707.02921 [cs], July 2017.
[9] X. Wang, K. Yu, S. Wu, J. Gu, Y. Liu, C. Dong, C. C. Loy, Y. Qiao, and X. Tang, “ESRGAN: Enhanced Super Resolution Generative Adversarial Networks,” arXiv: 1809.00219 [cs], September 2018.

### SUMMARY OF THE INVENTION

The present invention proposes a super-resolution reconstruction device for Micro CT images of rat ankle fractures. By incorporating Res2Net, the model gains multi-scale feature extraction capability, resulting in superior reconstruction outcomes. The technical solution is outlined as follows:
A super-resolution reconstruction device for Micro CT images of rat ankle fractures, comprising a rat ankle image preprocessing module, an HR LR image pairing module, a deep model module, and an image super-resolution reconstruction module, wherein the rat ankle image preprocessing module, the HR LR image pairing module, the deep model module, and the image super-resolution reconstruction module are sequentially interconnected;
The deep model module is a Res2Net-based deep model module with residual channel attention;
The deep model module encompasses a shallow feature extraction layer, a deep feature extraction layer, and a feature upsampling layer.

The rat ankle image preprocessing module is responsible for performing high-resolution and low-resolution scans of the tibia to ankle region of rats with simulated ankle fractures, thereby obtaining high-resolution image HR and the corresponding low-resolution image LR, with a resolution discrepancy of 8 times.

The HR LR image pairing module is employed to generate training data for the Res2Net-based deep model with residual channel attention. This process involves using a feature detection algorithm to identify feature points and matching feature points in LR and HR images acquired from the same scanning position. Subsequently, the LR image is rotated to align with the HR image based on the two sets of feature points, and HR and LR sub-images are cropped with the feature points as the center to construct HR LR image pairs;

The Res2Net-based deep model module with residual channel attention comprises a shallow feature extraction layer, a deep feature extraction layer, and a feature upsampling layer:
The shallow feature extraction layer is implemented as a 3×3 convolutional layer that takes the LR image as input and generates the shallow feature map F0;
The deep feature extraction layer comprises two components: an RCAB group based on channel attention and a Res2 group based on Res2Net. The RCAB group consists of ten RCAB units with short skip connections, while the Res2 group builds upon Res2Net and incorporates five Res2blocks with short skip connections to mitigate over-fitting during model training. The shallow feature map F0 is transformed into feature map F1 through the first RCAB group. Feature map F1 is then processed by the first Res2 group to yield feature map F2, and subsequently, feature map F2 is further modified by the second RCAB group to produce feature map F2. This process continues iteratively, with feature map F2 being processed by the second Res2 group to generate feature map F3, and so on. Five such alternating cascaded connections, coupled with long skip connections, are employed, ultimately resulting in feature map F10;
To obtain feature map F1 through the first RCAB group from the shallow feature map F0, the following methodology is employed: The shallow feature map F0 is sequentially fed into ten RCAB units. When F0 enters the first RCAB unit, it undergoes a 3×3 convolution operation, followed by ReLU activation and another 3×3 convolution, thereby producing feature map X0,1. Subsequently, feature map X0,1 is inputted into the channel attention mechanism layer, where it undergoes global average pooling to compress it into a 1×1 vector. This vector then passes through a 1×1 convolutional layer and ReLU activation to reduce the channel dimension. Finally, a 1×1 convolutional layer and Sigmoid activation function generate attention weights, which are element-wise multiplied with the input feature map X0,1, resulting in the generation of a new feature map F0,1. Feature map F0,1 then sequentially passes through the second to tenth RCAB units, giving rise to feature map F1 through the first RCAB group;
The method for obtaining feature map F2 through the first Res2 group from feature map F1 is as follows: Feature map F1 is successively fed into five Res2blocks. After passing through the first Res2block, feature map F1 undergoes a 1×1 convolutional layer and is partitioned into four sub-feature maps, Xi (where i ranges from 1 to 4). Each sub-feature map possesses one-fourth of the channels of feature map F1. Specifically, sub-feature map X1 remains unchanged and is obtained directly without undergoing any convolutional operation. Sub-feature map X2 undergoes a 3×3 convolution operation, resulting in sub-feature map Y2. Subsequently, sub-feature map X3 is added to the previous result, Y2, and the summation is then processed by a 3×3 convolution, leading to the generation of sub-feature map Y3;
Likewise, sub-feature map X4 is added to the previous result, Y3, and the summation is processed by a 3×3 convolution, yielding sub-feature map Y4. By employing the aforementioned operations iteratively, the receptive field is continuously expanded, thereby obtaining four multi-scale sub-feature maps, namely, Y1, Y2, Y3, Y4. These sub-feature maps are fused together to obtain the output result of the first Res2 group. The process is then repeated with four identical Res2blocks, resulting in the generation of feature map F2;
The feature upsampling layer consists of a sub-pixel convolutional layer that performs upsampling on the final feature map F10, thereby increasing the resolution of the original input image by a factor of 8. Subsequently, a 3×3 convolutional layer is employed to reduce the channel dimension of the feature map to a final image with channel-3;
The image super-resolution reconstruction module is designed to reconstruct LR images into HR images, thereby achieving super-resolution reconstruction of rat ankle bone fracture Micro CT images.

Moreover, the AKAZA feature detection algorithm is applied for feature point detection, followed by the utilization of the Brute Force algorithm to match corresponding feature points in LR and HR images acquired at the same scanning position.

The present invention offers the following advantageous effects: By incorporating Res2Net, the model demonstrates the ability to extract multi-scale features, resulting in superior reconstruction performance. HR LR image pairs are created using image processing techniques for feature point detection and matching, serving as training data for the super-resolution model. Additionally, image cropping is performed to facilitate deep learning training. An improved version of the RCAN model, referred to as R2 RCAN, is proposed in this invention. RCAN is a super-resolution reconstruction model based on self-attention mechanism, while the integration of Res2Net enables the model to extract features at multiple scales. Compared with other classic super-resolution models, the proposed R2 RCAN model achieved the best results.

### BRIEF DESCRIPTION OF THE FIGURES

FIG. 1 is a flowchart of the present invention;

FIG. 2 is an illustration of the architecture of the R2-RCAN super-resolution model;

FIG. 3 is an illustration of the channel attention mechanism;

FIG. 4 is an illustration of the structure of the RCAB;

FIG. 5 is an illustration of the structure of the Res2block.

### DETAILED DESCRIPTION OF THE INVENTION

To provide a comprehensive explanation of the present invention, specific examples and accompanying figures are employed to describe the detailed implementation process.

The present invention introduces a device for super-resolution reconstruction of rat ankle fracture Micro-CT images. The device comprises a rat ankle image preprocessing module, an HR-LR image pair configuration module, an R2-RCAN deep model module, and an image super-resolution reconstruction module. Firstly, skilled operators perform fracture modeling on the ankle region of a live rat and subsequently immobilize the rat in a Micro-CT scanner (Bruker model: SkyScan 1276). The scanner is then employed to acquire HR and LR images of the fractured region at high and low resolutions, respectively, with the HR images having an eight-fold higher resolution than the LR images. From the HR images, one image is selected for every eight images to correspond with an LR image. HR-LR image pairs are generated using image processing techniques, including feature point detection and matching, which are utilized as training data for the super-resolution model. Simultaneously, image cropping is conducted to facilitate deep learning training.

The present invention proposes an enhanced version of the RCAN model called R2-RCAN, which incorporates Res2Net to enable multi-scale feature extraction. Compared with other classic super-resolution models, the proposed R2-RCAN model achieved the best results.

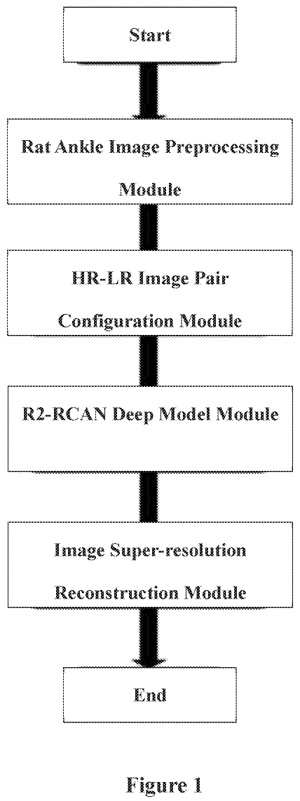

The overall process flow is depicted in FIG. 1, with detailed steps as follows:

Step 1: Rat ankle image preprocessing module. Initially, a professional operator conducts ankle fracture modeling in rats and performs scanning from the tibia to the ankle. The Micro-CT system used is the SkyScan 1276 by Bruker, equipped with a maintenance-free 20-100 kV micro-focused X-ray source and an automatic 6-position filter changer. It features an 11 Mp cooled X-ray camera, offering continuous variable magnification with a minimum pixel size of 2.8 micrometers. This system can resolve object details as small as 5-6 micrometers with a contrast exceeding 10%. The present invention focuses on achieving 8-fold super-resolution reconstruction. To ensure accurate results, the rats' positions are strictly fixed during both HR and LR scans. The imaging protocol involves one high-resolution scan with a resolution of 10 micrometers and one low-resolution scan with a resolution of 80 micrometers. This results in 4000 HR images and 500 LR images. From the sequence of eight high-resolution images, one HR image is selected for every corresponding LR image.

Step 2: HR-LR image pair configuration module. Micro-CT, renowned for its superior spatial resolution, plays a vital role in small animal imaging research. Nonetheless, it suffers from reduced temporal resolution. When imaging live animals, the Micro-CT system's operation time often spans several respiratory cycles of the small animal under examination. Despite precise positioning of the rats in the present invention's super-resolution reconstruction of the fractured area, image misalignment can occur due to prolonged imaging duration and respiration-induced motion. To mitigate this challenge, the present invention employs the AKAZA feature detection algorithm from OpenCV [1] to detect feature points and employs the Brute-Force algorithm [2] to match feature points between LR and HR images acquired at the same scanning position. Two sets of feature points, denoted as “a-A” and “b-B” (where “a” and “b” represent LR feature points, and “A” and “B” represent HR feature points), are randomly selected. The angular difference between “ab” and the horizontal direction is computed using Equation (1):

$${θ}_{ab} = arc tan ( \frac{{x}_{a} - {x}_{b}}{{y}_{a} - {y}_{b}} ) \qquad ( 1 )$$

where (xₐ, yₐ) and (x_{b}, y_{b}) represent the coordinates of points “a” and “b”, respectively. Similarly, the angular difference between “AB” and the horizontal direction is calculated. LR images are then rotated to align with HR images by the determined rotation angle, based on the feature points. Subsequently, LR-HR images are cropped around the corresponding feature point pairs, resulting in LR images of size 40×40 pixels and HR images of size 320×320 pixels. A total of 960 well-structured image pairs are selected, with 800 pairs assigned for training, 80 pairs for validation, and 80 pairs for testing. This process of generating LR-HR image pairs not only addresses image misalignment issues but also facilitates subsequent deep learning training by conveniently cropping the images.

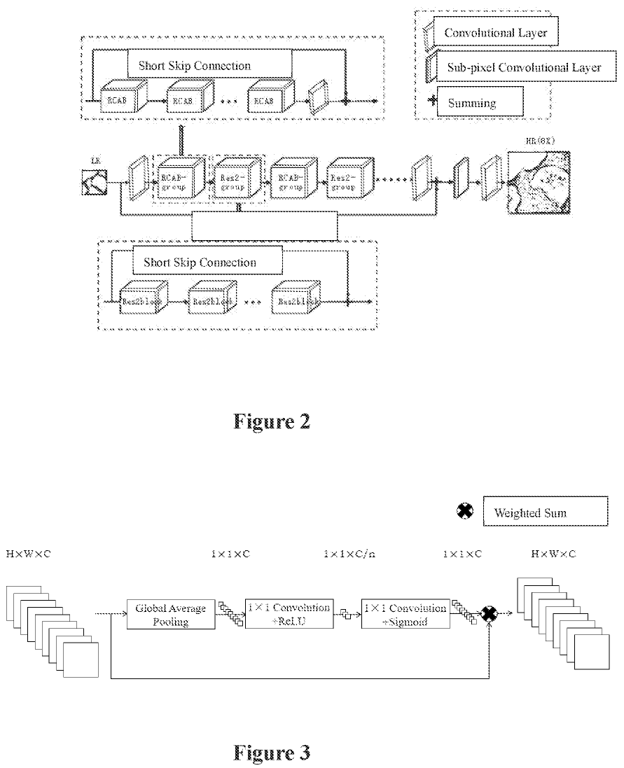

Step 3: The overall architecture of R2-RCAN is illustrated in FIG. 2. The model has increased width while maintaining a certain depth, which enables it to extract multi-scale features. It includes a shallow feature extraction layer, a deep feature extraction layer composed of several RCAB-groups and Res2-groups, and a feature upsampling layer based on sub-pixel convolution.

The shallow feature extraction layer is used to extract coarse-grained features of the image, which is beneficial for the extraction of deep features. It consists of a 3×3 convolutional layer, which takes the image as input and outputs the shallow feature map.

The deep feature extraction layer is mainly composed of two parts: RCAB-group based on channel attention mechanism and Res2-group based on Res2Net.

The RCAB-group consists of 10 RCABs with short skip connections. The RCAB is a residual structure based on the channel attention mechanism [3], which is designed to make the network pay more attention to useful information in the image. By utilizing the dependency between feature channels, it assigns higher weights to the low-frequency and valuable high-frequency information channels.

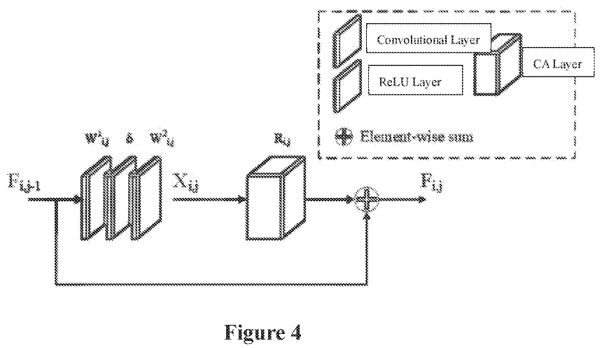

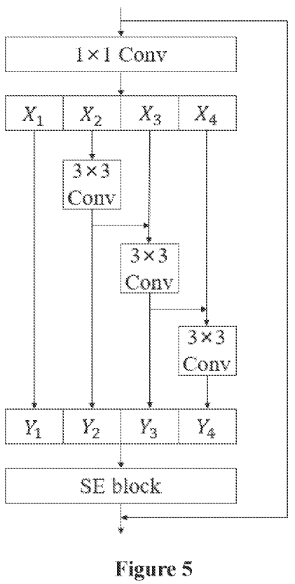

This leads to better super-resolution learning performance. The channel attention mechanism is illustrated in FIG. 3. The input feature map is first compressed into a 1×1 vector by a global average pooling layer. Then, the vector is passed through a 1×1 convolutional layer and ReLU activation function to reduce the number of channels. Finally, an attention weight is generated by a 1×1 convolutional layer and Sigmoid activation function, and the input feature map is multiplied by the weight to obtain a new feature map. The RCAB is obtained by incorporating the attention mechanism into the residual module, as shown in FIG. 4. It consists of two layers of 3×3 convolution and a CA layer, which is represented by Equation (2):

$${X}_{i - 1 , j} = {W}_{i , j}^{1} δ ( {W}_{i , j}^{2} {F}_{i - 1} ) \qquad ( 2 )$$

where i and j represent the j^{th} RCAB in the i^{th} RCAB-group, Fᵢ₋₁ represents the input, and X_{i-1,j} represents the output. W_{i,j}¹ and W_{i,j}² denote the two stacked convolutional layers, and δ represents the ReLU activation function. The residual information X_{i,j} is extracted through convolution, and then passed through the CA layer, as shown in Equation (3):

$${F}_{i - 1 , j} = {F}_{i , j - 1} + {R}_{i , j} ( {X}_{i - 1 , j} ) \cdot {X}_{i - 1 , j} \qquad ( 3 )$$

where Fi−1, j represents the output of this layer, and Ri, j represents the CA layer. As shown in FIG. 2, the RCAB-group consists of several RCAB layers, a convolutional layer, and a short skip connection. This stacked module with skip connections helps to increase the depth of the network and achieve better super-resolution results.

The Res2-group mainly consists of 5 Res2blocks stacked together. The Res2block used in the present invention is shown in FIG. 5, and it is the most basic module of Res2Net. Res2Net is a new variant of ResNet, which is a multi-scale residual unit structure [4]. Res2Net represents multi-scale features with finer granularity and increases the receptive field range of each network layer. After entering the Res2block, the feature map is divided into 4 blocks by the first 1×1 convolution, each of which is denoted as Xᵢ (i=1, 2, 3, 4), with a channel number of ¼ of the original. Apart from X₁, each block undergoes a 3×3 convolution, and the convolution result for each block is denoted as Yᵢ. Yᵢ₊₁ is obtained by adding the convolution result of Xᵢ₊₁ and the previous block's feature map Yᵢ, followed by a 3×3 convolution. This process allows for the generation of outputs with different quantities and receptive field sizes. Finally, an SE block is incorporated to assign weights to each channel [5], thereby enhancing the feature response of each channel. This approach of splitting and fusing enables the extraction of multi-scale features, improved feature fusion, increased receptive field of the network, representation of multi-scale features, and increased network width.

Step 4: The image super-resolution reconstruction module. During the training of R2-RCAN, data augmentation is performed by rotating and flipping the training data. Each training batch consists of 32 LR images as input. Our model is trained using the ADAM optimizer with β1=0.9 and β2=0.999. The initial learning rate is set to 10-4, and it is halved every 2×105 backpropagation iterations. The loss function applied is L1 loss, as shown in Equation (4):

$${L}_{1} = \frac{1}{H \times W} {\sum }_{i}^{H} {\sum }_{j}^{W} \vert {I}_{SR}^{( i , j )} - {I}_{HR}^{( i , j )} \vert \qquad ( 4 )$$

where H and W represent the height and width of the image, ISR and IHR represent the reconstructed image and HR image, respectively. The R2-RCAN structure consists of 5 RCAB-groups and 5 Res2-groups, with each group being alternately concatenated. Each RCAB-group contains 10 RCABs, and each Res2-group contains 5 res2blocks. Except for the convolution layers with convolution size of 1×1 in the channel downscaling and channel upscaling, the remaining convolution layers have a size of 3×3. We use PSNR and SSIM as evaluation metrics for super-resolution, as shown in Equations (5) and (6):

$$MSE = \frac{1}{H \times W} {\sum }_{i}^{H} {\sum }_{j}^{W} {( {I}_{SR}^{( i , j )} - {I}_{HR}^{( i , j )} )}^{2} \\ PSNR = 10 {log}_{10} ( \frac{{( {2}^{n} - 1 )}^{2}}{MSE} ) \qquad ( 5 )$$

where MSE represents the mean squared error between the reconstructed image and HR image.

$$L ( X , Y ) = \frac{2 {u}_{X} {u}_{Y} + {C}_{1}}{{u}_{X}^{2} + {u}_{Y}^{2} + {C}_{1}} \\ C ( X , Y ) = \frac{2 {σ}_{X} {σ}_{Y} + {C}_{2}}{{σ}_{X}^{2} + {σ}_{Y}^{2} + {C}_{2}} \\ S ( X , Y ) = \frac{{σ}_{XY} + {C}_{3}}{{σ}_{X} {σ}_{Y} + {C}_{3}} \\ SSIM ( X , Y ) = L ( X , Y ) * C ( X , Y ) * S ( X , Y ) \qquad ( 6 )$$

u_{X} and u_{Y} denote the means of images X and Y, σ_{X} and σ_{Y} represent the standard deviations of images X and Y, and σ_{XY} represents the covariance of images X and Y. C₁, C₂ and C₃ are constants. The model is compared with classic models such as Bicubic [6], SRCNN [7], EDSR [8], RRDBnet [9], ESRGAN [9], and RCAN [3], trained on the same dataset. The model is trained using the pytorch framework on an 2080ti gpu.

Table 1: Presents a quantitative comparison of the reconstruction results for rat ankle Micro-CT images using different models, where the bold font indicates the best results.

| Method | Reconstruction Factor | | |
|---|---|---|---|
| [symbol] | [symbol] | PSNR | SSIM |
| Bicubic [6] | ×8 | 20.36 | 0.62 |
| SRCNN[7] | ×8 | 20.60 | 0.64 |
| RRDBnet [9] | ×8 | 21.18 | 0.66 |
| ESRGAN[9] | ×8 | 19.93 | 0.57 |
| EDSR[8] | ×8 | 20.98 | 0.65 |
| RCAN[3] | ×8 | 21.39 | 0.63 |
| R2-RCAN | ×8 | 21.46 | 0.68 |

Table 1 compares the PSNR and SSIM values of various models for the reconstruction of rat ankle Micro-CT images. The references for the compared methods in Table 1 can be found in the background technology section.

The proposed R2-RCAN achieves the best performance in reconstructing rat ankle Micro-CT images at an 8-time magnification, with an average PSNR of 21.46 and SSIM of 0.68 on the test set.

The above-disclosed content illustrates and describes the fundamental principles, main features, and advantages of the present invention. The components mentioned in the present invention are common techniques in the relevant field, and should be understood by those skilled in the art. The embodiments and descriptions provided in the specification are merely illustrative of the principles of the present invention. The present invention is not limited to the disclosed embodiments, and various modifications and improvements can be made within the spirit and scope of the present invention, which are encompassed by the claims. The scope of protection of the present invention is defined by the appended claims and their equivalents.

1. A super-resolution reconstruction device for Micro CT images of rat ankle fractures comprising a rat ankle image preprocessing module, an HR LR image pair configuration module, a deep model module, and an image super-resolution reconstruction module, wherein the rat ankle image preprocessing module, the HR LR image pair configuration module, the deep model module, and the image super-resolution reconstruction module are interconnected sequentially.

2. The super-resolution reconstruction device for Micro CT images of rat ankle fractures according to claim 1, wherein the deep model module is a Res2Net-based deep model module with residual channel attention.

3. The super-resolution reconstruction device for Micro CT images of rat ankle fractures according to claim 1, wherein the deep model module comprises a shallow feature extraction layer, a deep feature extraction layer, and a feature upsampling layer.

4. The super-resolution reconstruction device for Micro CT images of rat ankle fractures according to claim 1, wherein the rat ankle image preprocessing module is used to perform high-resolution and low-resolution scans of the rat tibia and ankle after ankle fracture modeling to obtain high-resolution image HR and corresponding low-resolution image LR, with a resolution difference of 8 times;
the HR LR image pair configuration module is used to generate training data for a residual channel attention model based on Res2Net by detecting feature points and matching feature points of LR and HR images at the same scanning position. The LR image is rotated based on the two sets of feature points to align the LR image with the HR image, and HR and LR sub-images are cropped centered at the feature points to create HR LR image pairs;
the image super-resolution reconstruction module reconstructs the LR image into an HR image, thereby obtaining a super-resolution reconstruction image of Micro CT images of rat ankle fractures.

5. The super-resolution reconstruction device for Micro CT images of rat ankle fractures according to claim 3, wherein the shallow feature extraction layer is a 3×3 convolutional layer that takes the LR image as input and produces a shallow feature map F0;
the deep feature extraction layer consists of two parts, namely an RCAB group based on channel attention and a Res2 group based on Res 2Net. The RCAB group consists of 10 RCABs combined with short skip connections. The Res2 group, based on Res2Net, concatenates 5 Res2blocks combined with short skip connections to prevent over-fitting during model training. The shallow feature map F0 is passed through the first RCAB group to obtain feature map F1. Feature map F1 is then passed through the first Res2 group to obtain feature map F2, and feature map F2 is further processed by the second RCAB group to obtain feature map F2. This process continues, with feature map F2 being passed through the second Res2 group to obtain feature map F3, and so on, until feature map F10 is obtained using five iterations of alternating concatenation and long skip connections;
the method for obtaining feature map F1 from shallow feature map F0 through the first RCAB group, where shallow feature map F0 sequentially enters 10 RCABs, is as follows: when shallow feature map F0 enters the first RCAB, it is convolved with a 3×3 convolution, followed by ReLU activation function and another 3×3 convolution to obtain feature map X0,1. Then, feature map X0,1 is input into the channel attention mechanism layer, which compresses feature map X0,1 to a 1×1 vector through global average pooling layer. The vector is then passed through a 1×1 convolutional layer and ReLU activation function to reduce the number of channels. The attention weights are generated by passing the vector through another 1×1 convolutional layer and a Sigmoid activation function, and the resulting weights are multiplied element-wise with the input feature map X0,1 to obtain a new feature map F0,1. Feature map F0,1 is then sequentially processed through the second to the tenth RCAB, resulting in the feature map F1 obtained by the first RCAB group;
the method for obtaining feature map F2 from feature map F1 through the first Res2 group is as follows: feature map F1 sequentially enters 5 Res2blocks. When it enters the first Res2block, feature map F1 is convolved with a 1×1 convolutional layer and divided into 4 sub-feature maps Xi, where i ranges from 1 to 4. Each sub-feature map has ¼ of the channels of feature map F1. Sub-feature map X1 is not convolved and directly produces sub-feature map Y1. Sub-feature map X2 is convolved with a 3×3 convolution to obtain sub-feature map Y2. Sub-feature map X3 is added to the previous sub-feature map, and then convolved with a 3×3 convolution to obtain sub-feature map Y3;
Sub-feature map X4 is added to the previous sub-feature map Y3, and then convolved with a 3×3 convolution to obtain sub-feature map Y4. By continuously increasing the receptive field in this way, four multi-scale sub-feature maps are obtained: Y1, Y2, Y3, and Y4. These four multi-scale sub-feature maps are then fused to obtain the output result of the first Res2 group. This process is repeated for another 4 Res2blocks, resulting in feature map F2;
the feature upsampling layer, comprised of a sub-pixel convolutional layer, is employed to perform upsampling on the final feature map F10, effectively expanding the resolution of the initial input image by a factor of 8. Subsequently, a 3×3 convolutional layer is utilized to reduce the channel dimensions of the feature map, resulting in a final 3-channel image.

6. The device for super-resolution reconstruction of Micro CT images of rat ankle fractures as claimed in claim 1 is characterized in that the AKAZE feature detection algorithm is used to detect feature points, and the Brute Force algorithm is used to match feature points in the LR and HR images at the same scanning position.
